(19) United States
(12) Patent Application Publication
(10) Pub. No.: US 2021/0237599 A1
(43) Pub. Date: Aug. 5, 2021

(54) CHARGING STATION FOR ELECTRIC VEHICLES

(71) Applicants: Christian Müller-Winterberg, Dorsten (DE); Stefan Helnerus, Arnsberg (DE)

(72) Inventors: Christian Müller-Winterberg, Dorsten (DE); Stefan Helnerus, Arnsberg (DE)

(73) Assignee: innogy SE, Essen (DE)

(21) Appl. No.: 17/239,250

(22) Filed: Apr. 23, 2021

Related U.S. Application Data
(63) Continuation of application No. PCT/EP2019/076730, filed on Oct. 2, 2019.

(30) Foreign Application Priority Data
Oct. 29, 2018 (DE) 102018126947.1

(51) Int. Cl. B60L 53/31; B60L 53/67; B60L 53/30

(52) U.S. Cl. CPC B60L 53/31; B60L 53/305; B60L 53/67

(57) ABSTRACT

The application relates to a charging station for electric vehicles, comprising at least one charging column with a charging column housing, wherein at least one is arranged in the charging column housing, set up to receive a charging device corresponding to the receptacle with a charging device housing, wherein at least one charging technology module is integrated in the charging device housing, and wherein of the charging device housing and the charging column housing only the charging device housing is completely sealed.

### CROSS-REFERENCE TO RELATED PATENT APPLICATIONS

This patent application is a continuation of International Application No. PCT/EP2019/076730, filed on Oct. 2, 2019, which claims the benefit of priority to German Patent Application No. 10 2018 126 947.1, filed Oct. 29, 2018, the entire teachings and disclosures of both applications are incorporated herein by reference thereto.

### FIELD OF THE INVENTION

The application relates to a charging station for electric vehicles, comprising a charging column with a charging column housing, wherein a charging device is arranged in a receptacle of the charging column housing.

### BACKGROUND OF THE INVENTION

The development of the charging infrastructure is of decisive importance for the widespread establishment of electro mobility. To this end, it is particularly necessary to install charging stations for electric vehicles on a large scale in both public and partially public areas. The charging stations should fit into the street scene and are therefore usually designed as charging columns.

Charging columns are characterized, in particular, by a compact design with a small base area. The charging columns usually have a column-like structure and integrated or connectable charging electronics for charging an electric vehicle.

In the present context, an electric vehicle is understood to mean a vehicle that can be at least partially operated electrically and includes a rechargeable electric storage unit.

Known charging stations comprise a charging column with a charging column housing in which the charging technology is integrated. In order to protect the charging technology from environmental influences, such as water, dirt particles, etc., the charging column housing is completely sealed in an operational state of the charging station. In other words, the charging column housing provides an encapsulation for the charging technology arranged therein.

A disadvantage of such charging stations is that complete sealing of a large housing is very costly. This is all the more true if different inspection openings and/or doors have to be integrated in the charging column housing. The effort involved in manufacturing is further increased by the fact that a high quality of manufacturing is required for safe operation of the charging station.

Therefore, the object of the present application is to provide a charging station comprising a charging column with a charging column housing, which can be manufactured in a simpler manner and in which safe operation of the charging station is ensured at the same time.

### BRIEF SUMMARY OF THE INVENTION

The object is solved according to a first aspect of the application by a charging station according to claim 1. The charging station comprises at least one charging column with a charging column housing. In the charging column housing, at least one receptacle is arranged configured to receive a charging device with a charging device housing, wherein the charging device corresponds to the receptacle. At least one charging technology module is integrated in the charging device housing. Only the charging device housing from the charging device housing and the charging column housing is completely sealed.

In contrast to the prior art, a charging station is provided according to the application which can be manufactured in a simple manner and at the same time ensures safe operation. The charging station according to the application provides a complete encapsulation of the charging technology, which can be manufactured with less effort, in that only the charging device housing of the charging device housing and the charging column housing is completely sealed. In other words, the charging column housing is not completely sealed. In addition to reducing the effort required to manufacture the charging column housing, the manufacturing cost can be reduced. Furthermore, a higher overall quality of manufacturing of the charging station is provided, since only a relatively small housing is completely sealed to achieve sufficient protection of the charging technology from water, dirt particles, etc.

A charging device according to the application is configured for exchanging electrical energy with electric vehicles and is installed in a charging station in the intended use. For example, a charging cable can be connected between the charging device and the electric vehicle to be charged.

A charging station according to the application is preferably formed by a column-like charging column, which may for example comprise a foundation, a charging column base and/or a charging column head.

The charging column, preferably the charging column head, comprises at least one receptacle configured to receive and hold, respectively, the charging device. In the intended use, the charging device is, in particular, firmly fixed and mounted, respectively, in the receptacle.

In the charging column housing, the receptacle is formed by preferably at least one circumferential side wall of the charging column housing. A mains connection cable can be provided and passed through, respectively, within this receptacle, which is insertable into the charging device via a (sealed) cable entry of the charging device. By the mains connection cable, the charging station can be connected to an energy source, in particular, a supply network and/or a generator.

The charging device comprises a charging device housing that is fully sealed when the charging device is in the mounted (assembled) state. In the present context, a completely sealed housing means, in particular, that an encapsulation is provided for the (electrical) components arranged inside the housing, in particular, at least for the charging technology. The encapsulation prevents water and/or dirt particles from entering the housing in the assembled state.

According to the application, it is provided that at least the charging technology is completely encapsulated in the charging device. This can eliminate the need for complete encapsulation of the charging column housing.

According to a first embodiment of the charging station according to the application, the charging device housing can be at least completely sealed with a tightness (and degree of protection, respectively) of IP55 according to the standard DIN EN 60529. In other words, according to this embodiment, a charging device housing is provided which provides protection against jet water (nozzle) from any angle and protection against contact and dust. A charging station placed in public as well as in partially public areas can be operated safely.

Preferably, the charging column housing can, as has already been described, not be completely sealed, in particular, not with a tightness of IP55 according to the standard DIN EN 60529. This allows a particularly simple manufacture of the charging column housing.

According to a preferred embodiment of the charging station according to the application, the charging device may comprise a charging unit connectable (mechanically and electrically) to a docking station. The docking station may comprise at least one (housing) bottom and at least one first circumferential (housing) side wall. The charging unit may have at least one (housing) cover and at least one second circumferential (housing) side wall. In the assembled state of the charging device, i.e. when the charging unit and the docking station are at least mechanically, preferably also electrically, coupled and connected, respectively, to each other, at least the bottom, the first side wall, the second side wall and the cover may form the charging device housing of the charging device.

According to this particularly preferred embodiment, the charging device is formed in a modular manner and comprises a docking station and a charging unit. The docking station is designed, in particular, as a connection level. The charging unit is formed, in particular, as a supply level and can preferably be placed on the docking station. Due to the fully sealed charging device housing according to the application, both the electrical components of the connection level and the electrical components of the supply level, in particular, the charging technology, are fully encapsulated and sufficiently protected from environmental influences.

Preferably, the charging unit may comprise a tub assembly and a cover assembly. The tub assembly may have a tub bottom and at least partially the second side wall. The cover assembly may comprise the cover. The cover assembly may preferably correspond over its entire surface to the tub assembly and be sealingly connectable to the tub assembly by means of snap elements, which, in particular, snap to the inner side of the second side wall of the tub assembly. For fixing, in particular, a plurality of snap elements is provided on the side walls of the cover assembly, which can preferably snap on inner sides of the side walls of the tub assembly. It shall be understood that in other variants, the snap elements may also be positioned at another position.

The cover assembly can be (mechanically) connected to the tub assembly by means of the snap elements. The snap elements can be such that by an engaging (behind) the cover assembly is fixed to the tub assembly.

In addition, a sealing element can be provided which is supported in a sealing manner between the cover assembly and the tub assembly in a fixed state of the cover assembly to the tub assembly. Preferably, a circumferential sealing lip may be arranged on the at least one second side wall, in particular, on the upper edge of the second side wall, which sealing lip is pressed against the edges of the side walls of the cover assembly and the tub assembly in the assembled state. The sealing lip may be formed of a suitable material.

Furthermore, the snap elements can be such that they can only be released from the bottom side, i.e. exclusively when the tub assembly is mechanically detached from the docking station. This increases safety, since contact protection is always provided by the cover assembly and the cover assembly cannot be lifted off the tub assembly as long as the tub assembly rests on the docking station on the bottom side, as will be explained below.

Only when the tub assembly has been removed from the docking station, and thus it is imperative that the charging unit is free of electrical voltage, the cover assembly can be released from the tub assembly by releasing the snap elements.

According to a preferred embodiment of the charging station according to the application, the tub assembly may receive the charging technology module, in particular, in the form of at least one printed circuit board. The cover assembly may receive a communication module and/or a user interface module. In particular, the charging assembly may receive the charging technology module that forms at least one power module, the communication module, and the user interface module such that, starting from the cover surface, first the user interface module, then the communication module, and then the power module are arranged.

As has already been described, at least one power module may be disposed in the tub assembly. The power module, also referred to as the high power safety (HPS) module, in particular, comprises components necessary for power control and power monitoring.

Furthermore, a first charge control circuit as well as a charge outlet may be arranged within the tub assembly. The components arranged within the tub assembly may be sufficient to provide basic functionalities for charging an electric vehicle and may, for example, be arranged on a common printed circuit board.

In other words, the charging technology module may preferably be arranged in the tub assembly.

Preferably, the tub assembly comprises a bottom, which may face a protective housing cover of the docking station when the charging device is mounted. The side of the tub assembly opposite the bottom is preferably sealed by the cover assembly, as has already been explained.

In particular, the cover assembly serves to accommodate at least one communication module and at least one user interface module. The communication module can be used, for example, to extend the charging functions of the power module and, in particular, to implement extended protocol functionalities. A user interface module makes it possible, in particular, to implement interaction with a user. The power module is preferably configured to provide a power supply for a communication module and/or a user interface module.

The communication module may optionally be connected to a wide area network connection disposed within the docking station. Also, the communication module may optionally be connected to a connection to a charging network within the docking station.

Also, the communication module may establish communication in a near field (e.g., Bluetooth, WLAN (Wireless Local Area Network), etc.) and may comprise appropriate antennas for this purpose.

The communication module, also called ECU (Electronic Control Unit) module, can act as a control computer and communication gateway.

The user interface module, also called UIB (User Interface Board) module, comprises, in particular, user operating elements and/or display elements, for example in each case at least one display, a touch display, a pictogram, a capacitive/inductive touch sensor and/or an environment sensor. These can be controlled and/or read out by the UIB. The UIB can be connected to the ECU module in a modular fashion within the charging unit, whereby a UIB in a basic function can have only status LEDs for displaying the operating status as a display element, and in a multi-element configuration can have and/or control at least one of the additional operating elements and/or display elements mentioned above.

The charging unit can be electrically coupled to the docking station via a power connection. In particular, in the assembled state of the charging device, i.e. when the charging unit is mechanically coupled to the docking station, an electrical coupling is (automatically) provided by the power connection between the docking station and the charging unit, as will be explained in more detail.

For a mechanical coupling of the charging unit to the docking station, according to a preferred embodiment, it is proposed that bottom side arranged bars can extend facing away from the interior of the tub assembly. In particular, the bars are arranged to engage in recesses on the docking station in such a way that the bars can be positively fixed to the docking station in order to couple the docking station to the charging unit, in particular, in a sealing manner.

For a (permanent) locking of the charging unit to the docking station, for example, a locking module can be provided which is movable at least between an open position and a locking position. In particular, the locking module interacts with the bars of the charging unit in such a way that, in the open position, the bars are insertable into the corresponding recesses of the docking station as far as to a snapping position, usually an end position, and are positively fixable to the docking station by moving the locking module into the locking position.

For fixation, in particular, each bar may comprise a first locking element and the locking module may have a corresponding plurality of second locking elements, each corresponding to the respective first locking element. Corresponding in the present context means, in particular, that the first locking elements and second locking elements are shaped in such a way that, in the open position, the locking elements arranged on the bars insertable into the recesses of the docking station until the snapping position is reached and interact with the second locking elements in such a way that, in the snapping position, it is possible to move the locking module into the locking position and, in this locking position, a fixation of the bars can be carried out. Preferably, a first locking element can be snapped with a corresponding second locking element in the locking position.

In particular, the first locking elements interact with the second locking elements in such a way that the bars are positively fixable to the docking station. In other words, a movement of the bars out of the recesses of the docking station in the locking position can be blocked by the interaction of the locking elements, so that, in particular, the charging unit is fixed and locked, respectively, to the docking station.

Particularly preferably, the docking station may comprise a protective housing cover. The at least one first side wall can project in a collar shape manner beyond the protective housing cover in the assembled state of the protective housing cover, i.e. when the protective housing cover closes the docking station and is snapped (latched) to the first side wall via suitable snap (latching) elements, for example.

According to a particularly preferred embodiment of the charging station according to the application, the second side wall can correspond to the first side wall in such a way that, in the assembled state of the charging device, the second side wall circumferentially encloses the first side wall. At least one circumferential sealing element, preferably in the form of a circumferential sealing lip, may be provided which is held in a clamped manner between the first side wall and the second side wall in the assembled state of the charging device.

In other words, at least one sealing element may be provided between the docking station and the charging unit. In the locking position of the locking module (in which, in particular, all the bars may be in the snapping position) and in the assembled state, respectively, of the charging device, a seal may be provided between the docking station and the charging unit. In particular, in the locked position and the assembled state of the charging device, respectively, a clamping of the sealing element (e.g., a compression of a foam seal or the like) between the charging unit, in particular, the tub assembly of the charging unit, and the docking station, in particular, the protective cover housing of the docking station, can be provided and, in particular, maintained in the assembled state of the charging device. In particular, the bars, recesses and locking module may be dimensioned and designed accordingly.

Preferably, it may be provided that the protective housing cover recedes (recesses) from the upper plane of the docking station, so that the side walls of the docking station in the assembled state of the protective housing cover protrude over the latter in a collar-like manner, as already explained above. This enables by the first and second side walls to ensure a sealing of the docking station in the assembled state of the charging device, for example, by providing in the charging unit corresponding to the first and second side walls as a sealing element at least one circumferential sealing lip which is pressed against the edges of the side walls of the first and second side walls in the assembled state. It can be held there, in particular, due to the locking mechanism described above. The fact that the protective housing cover springs back (recedes) can ensure that the at least one sealing lip can completely engage around the side walls.

In the assembled state of the charging device, according to a further embodiment, at least one first opening and recess, respectively, preferably a plurality of first openings in the protective housing cover can correspond to at least one second opening and recess, respectively, preferably a corresponding plurality of openings in the tub bottom, in such a way that a power connection and/or a communication connection between the charging unit and the docking station can be established through the first opening and the second opening. By corresponding is meant, in particular, that in the assembled state the first opening is located substantially above the second opening.

Due to the mechanical coupling between the charging unit and the docking station described above, which provides a complete seal, the power connection and/or a communication connection can be sufficiently protected from water, dirt particles, contact, etc.

For example, a printed circuit board can be arranged inside the docking station as a mains board, which has a first power connection that can be electrically and mechanically coupled to a further power connection of the charging unit through the first and second openings. Preferably, in addition, a first data port of the docking station can be coupled to a second data port of the charging unit through a further first opening and a further second opening.

Furthermore, at least one plate receptacle may be provided in the first side wall of the docking station in which a removable cable feed-through plate may be inserted. In order to insert a power supply cable into the docking station in a sealing manner, an edge region of the at least one cable feed-through plate may preferably comprise at least partially at least one sealing element (in particular, a sealing ring). The sealing element may, for example, correspond to a recess of the plate receptacle. In an inserted state, the cable feed-through plate can be sealingly held in the plate receptacle. In particular, pressure can be exerted on the cable feed-through plate by the protective housing cover in the fixed state of the protective housing cover so that the cable feed-through plate is held sealingly in the plate receptacle.

The cable feed-through plate may be formed in one piece and include the sealing element, which may be formed of a different material, in particular, a different plastic component, than the rest of the plate area.

A housing cable opening may be established or at least be establishable in the cable feed-through plate for a passage of the power supply cable. According to an embodiment, inserting the power supply cable into the established housing cable opening may comprise mounting a cable gland to the established housing cable opening. By a cable gland the fed-through cable can be fixed to the housing cable opening. In particular, the cable gland comprises a sealing element to prevent water from entering. For example, a special tool specifically adapted to the used cable gland can be used.

In the event that it is necessary to integrate further electrical components and structure elements, respectively, in the charging station, according to a further embodiment, a distribution box can be integrated in the charging column housing. The distribution box may be arranged to accommodate at least one further electrical component. The distributor box can be formed in a completely sealing manner and, in particular, encapsulate the at least one electrical component.

According to a further, particularly preferred embodiment, the docking station can be mountable in the receptacle of the charging column by establishing at least one mounting connection (between charging column and docking station), in particular, a screw connection, through at least one opening arranged in the bottom of the docking station, preferably a plurality of openings arranged in the bottom of the docking station.

In the mounted state of the docking station, the at least one opening in the bottom of the docking station may be sealed by a sealing plug. In particular, a screw located in the opening, in the mounted state, may be sealed by a sealing plug. A simple mechanical attachment of the docking station to the charging column can be provided. At the same time, penetration of water and dirt particles into the charging device housing can be prevented in an effective manner.

Furthermore, there may preferably be an annular gap between the docking station and the at least one circumferential side wall forming the receptacle when the docking station is in mounted state. The annular gap may be engaged by the second side wall of the charging unit electrically and mechanically connected to the docking station in the mounted state of the charging device.

In particular, after the previously described installation of the docking station in the receptacle, an annular gap can form between the side wall of the docking station and the receptacle due to the dimensioning of the docking station for the receptacle, and the housing wall of the charging unit can engage in this annular gap. When the charging unit is coupled to the docking station, the charging unit is preferably placed on the docking station from above. The at least one circumferential side wall of the charging unit can engage in the annular gap so that it is not apparent from the outside of the charging column that the charging unit is placed on a docking station.

The charging column, in particular a charging column head, can also have a receptacle for a docking station on each of two opposing front surfaces.

### BRIEF DESCRIPTION OF THE DRAWINGS

There are now a plurality of possibilities for designing and further developing the charging station according to the application. In this regard, reference is made on the one hand to the patent claims subordinate to the independent patent claims, and on the other hand to the description of embodiment examples in conjunction with the drawing. In the drawing shows:

FIG. 1 is a schematic view of an embodiment of a charging station;

FIG. 2 is an exploded view of a charging station with docking station and charging unit;

FIG. 3 is a view of an opened docking station:

FIG. 4 is a view of a closed docking station;

FIG. 4a is a further view of the docking station:

FIG. 4b is a still further view of the docking station;

FIG. 5 is an exploded view of a tub assembly;

FIG. 6 shows a tub assembly in a partially assembled state;

FIG. 7 shows a tub assembly from below;

FIGS. 8a-c show assembled tub assemblies without covers:

FIG. 9 is a view of a cover assembly;

FIG. 10 is a bottom view of a cover assembly;

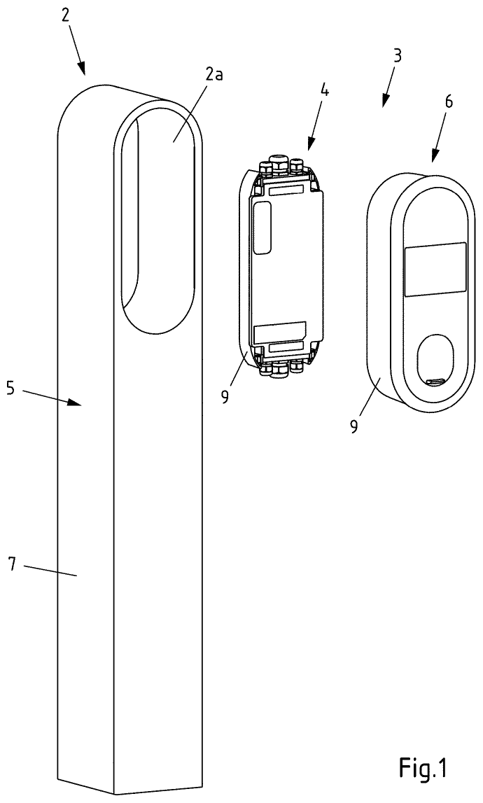

FIG. 1I is a sectional view of a cover assembly;

FIG. 12 is a schematic view of an embodiment of a charging station; and

FIG. 13 is a schematic view of a further embodiment of a charging station.

### DETAILED DESCRIPTION OF THE INVENTION

FIG. 1 shows a charging station 2 with a charging column 5. The charging column 5 comprises a charging column housing 7 in which a receptacle 2a is provided. The receptacle 2a of the charging column 5 is provided for receiving a charging device 3.

The charging device has a charging device housing 9 and is formed in a modular manner in the present case. According to the application only the charging device housing 9 of (from, respectively) the charging column housing 7 and the charging device housing 9 is completely sealed, in particular, with the protection class IP55 according to the standard DIN EN 60529, while the charging column housing 7 is not completely sealed.

In the present case, the charging device 3 is formed by a docking station 4 and a charging unit 6, each of comprise has a housing. The respective housings together form, at least in part, the charging device housing 9, as will be explained in more detail.

The docking station 4 can be fixed in the receptacle 2a, for example, screwed, as will be explained in more detail. An electrical connection (not shown) to a power supply network can be introduced into the docking station 4 via the charging station 2. The charging unit 6 may be assembled as a tub assembly and a cover assembly, which will be described in more detail below, and may be placed on the docking station 4 and electrically and mechanically fixed to the docking station 4.

Together with the mechanical fixation, the charging unit 6 may be electrically coupled to the docking station 4 via a plug/socket. A communication coupling may be provided via at least one patch cable between the docking station 4 and the charging unit 6.

In the installed state, the docking station 4 is completely received in the receptacle 2a and the charging unit 6 substantially completely surrounds the outer edge of the docking station 4 and is also at least partially recessed in the receptacle 2 with its side edges.

If necessary, however, the docking station 4 can also be mounted directly on a wall without the need for the charging column 2 with the receptacle 2a. In this case, too, the side walls of the docking station are at least partially enclosed by side walls of the charging unit 6.

As can be seen from FIG. 1, the base area of the docking station 4 and the charging unit 6 are approximately congruent with each other, so that when mounted and viewed from the front, the charging unit 6 completely covers the docking station 4.

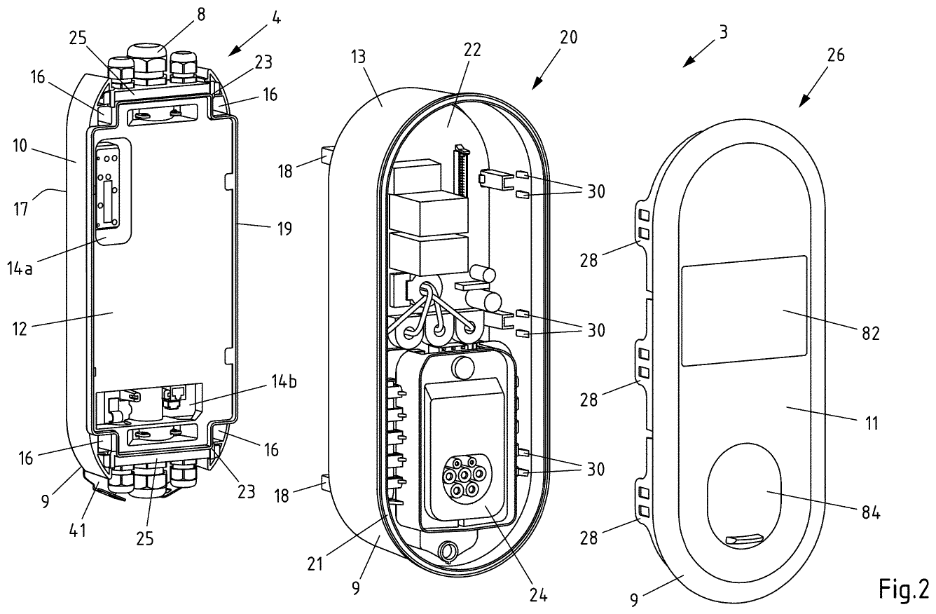

The modular structure of the present embodiment of the docking station 4 and the charging unit 6 is shown in more detail in FIG. 2.

In FIG. 2, the docking station 4 is first shown, which comprises a cable entry 8, in particular, in the form of a cable gland 8, in a first circumferential side wall 10 of the docking station 4.

In particular, a detachable cable feed-through plate 25 is provided in a plate receptacle 23 corresponding thereto, which is arranged in the first circumferential side wall 10. The cable feed-through plate 25 may have a circumferential seal in its edge region. In the assembled state of the docking station 4, the cable feed-through plate 25 is held in a clamped in the plate receptacle 23, in particular, by the protective housing cover 12, so that a sufficient seal of the docking station 4 is provided by the seal and the sealing element, respectively, of the cable feed-through plate 25.

A housing cable opening may be established or be at least establishable in the cable feed-through plate 25 for a passage of the power connection cable. Inserting the power connection cable into the established housing cable opening may comprise mounting a cable gland 8 to the established housing cable opening. The cable gland 8 may fix the fed-through cable to the housing cable opening. In particular, the cable gland 8 comprises a sealing element to prevent water from entering.

The docking station 4 is at least partially closed by a protective housing cover 12 on the side facing the charging unit 6. Preferably, first recesses 14a, 14b and first openings 14a, 14b, respectively, are provided in the protective housing cover 12, which will be described in more detail below.

Preferably, the charging unit 6 may be formed by a tub assembly 20 and a cover assembly 26.

Openings 16 may be provided between the protective housing cover 12 and the first side wall 10. Through these openings 16, bars 18 of the tub assembly 20 can be inserted into the docking station 4 so that the tub assembly 20 can be fixed to the docking station 4 via the bars 18. In other words, the charging unit 6 can thereby be mechanically fixed to the docking station.

For this purpose, in particular, a locking module 41 in the form of a locking bracket 41 is fixedly integrated in the docking station 4. The locking bracket 41 can be moved between an open position, in which the bars 18 can be inserted into the recesses 16 to an end position, and a locking position, in which the locking bracket is positively fixed to the bars 18. In the locking position, the locking module 41 is locked to the bars 18 such that movement of the bars 18 out of the recesses (receptacles) 16 is blocked.

Furthermore, a circumferential sealing element 19 is provided, which is clamped in an assembled state of the charging device 3 and thus sealingly held between the first side wall 10 and the second circumferential side wall 13 of the charging unit 6. By being locked by the locking module 41, the sealing element 19 remains in the clamped position. This will be described in further detail below.

As previously explained, the tub assembly 20 can be coupled to the docking station 4. In the present embodiment, the tub assembly 20 is part of the charging unit 6, which also includes the cover assembly 26. The tub assembly 20 accommodates a power module 22 and a charging socket 24. The tub assembly 20 is substantially closed on the bottom side with a bottom, and is closed on the cover side by the cover assembly 26.

The circumferential second side wall 13 and the cover 11 of the cover assembly 26 preferably together with the first circumferential side wall 10 and the bottom 17 of the docking station 4 (substantially) form the charging device housing 9 of the charging device 3.

Via snap (latching) elements 28, the cover assembly 26 can preferably be fixed to snap (latching) elements 30 in the side walls of the tub assembly 20. In particular, a circumferential sealing element 21 may provide a sufficient seal in the fixed state of the cover assembly 26 with the tub assembly 20.

The cover assembly 26 may include a shutter 84 and control elements, such as a display 34.

In the joined and fixed state, respectively, the cover assembly 26 is mechanically joined to the tub assembly 20 and thus seals the tub assembly 20 on a top side. On a bottom side, the tub assembly 20 is joined to the docking station 4 and the previously described sealing between the docking station 4 and the tub assembly 20 is carried out via the at least one first circumferential side wall 10.

Between the cover assembly 26 and the tub assembly 20, a seal is made along the outer edge 21 formed as a sealing element facing the cover assembly 26.

The docking station 4 serves as a connection level and can be connected to a power supply network independently of the charging unit 6. As long as the charging unit 6 is not coupled to the docking station 4, the charging unit 6 is voltage-free. By coupling the charging unit 6 to the docking station 4, the charging unit 6 is connected to the power supply network. The charging unit 6 can be understood as a supply level, which comprises at least one charging technology module, comprising the charging technology, and other “intelligence”. This modular design makes it possible to first assemble the docking station 4 by a fitter qualified to do so, without the need to immediately assemble a charging unit 6.

The charging unit 6 can be coupled to the docking station 4 at any later time, even by a technical layman, in a particularly simple manner, mechanically without tools, which then automatically electrifies the charging unit 6. The charging unit 6 is particularly flexible and modular due to its special design consisting of a tub assembly 20 and a cover assembly 26, as explained previously, and can be coupled to the respective application.

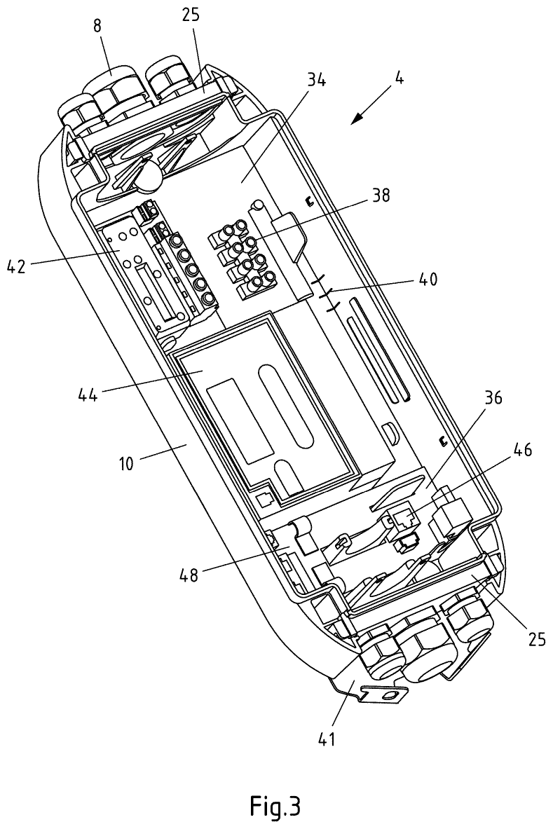

The docking station 4 is shown in more detail in FIG. 3. The docking station 4 comprises a bottom 17 and at least one first circumferential side wall 10. A mains board 34 and an interface board 36 are arranged on the base 17 of the docking station 4. A connector strip 38 is provided on the mains board 34 for connecting a power supply cable, which can be inserted according to the above embodiments.

Scale bars 40 may be provided on the first side wall 10 and/or the bottom 17.

In addition to the connection strip 38, a first power connection 42 is also arranged on the mains board 34 as a socket.

Furthermore, a receptacle 44 is provided between the first circumferential side wall 10. The receptacle 44 is closable by a cover. A measuring device, for example, a smart meter or an iMS, can be anchored in the receptacle 44 in a snapped manner. Not shown are cable through-feeds (bushings) through the side walls of the receptacle 44 for wiring the measuring device. The receptacle 44 can be sealed via suitable holes, which is not shown in detail.

Connectors 46,48 are provided on the interface board 36 for a network cable and for a CAN bus and/or a GPIO bus. In addition, connector sockets may still be provided for connection to modules within the charging unit.

The external wiring with a local network is carried out via a connection strip, which can then be tapped via an RJ45 socket. In particular, sufficient contacts are provided here to connect at least two independent local networks. For example, a first local network can be formed with a central unit and a second local network between master and slave units, i.e. between a charging unit with a master controller with at least one, preferably several charging unit(s) with only one slave controller. The two local networks can be connected together via a single patch cable to the charging unit 6 and the modules arranged therein, respectively.

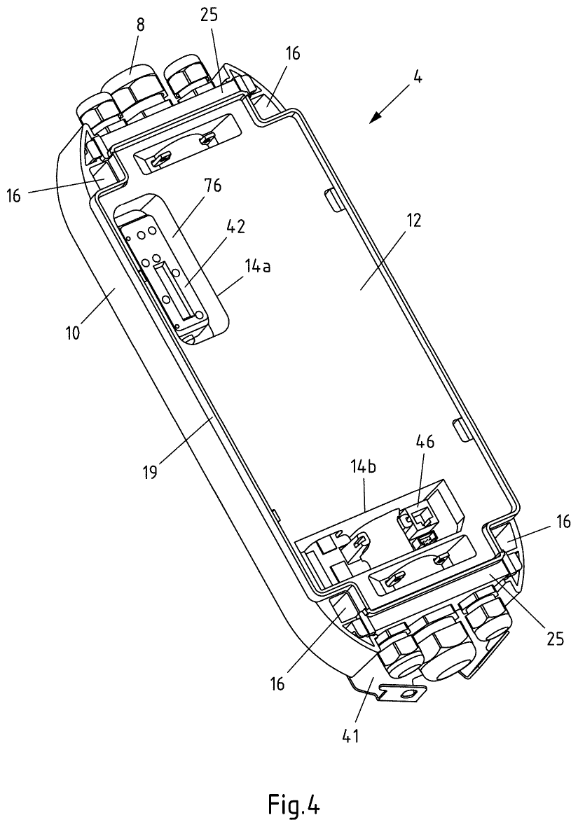

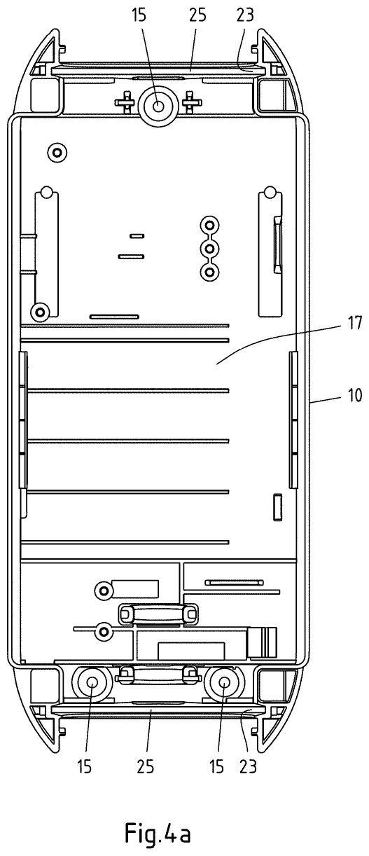

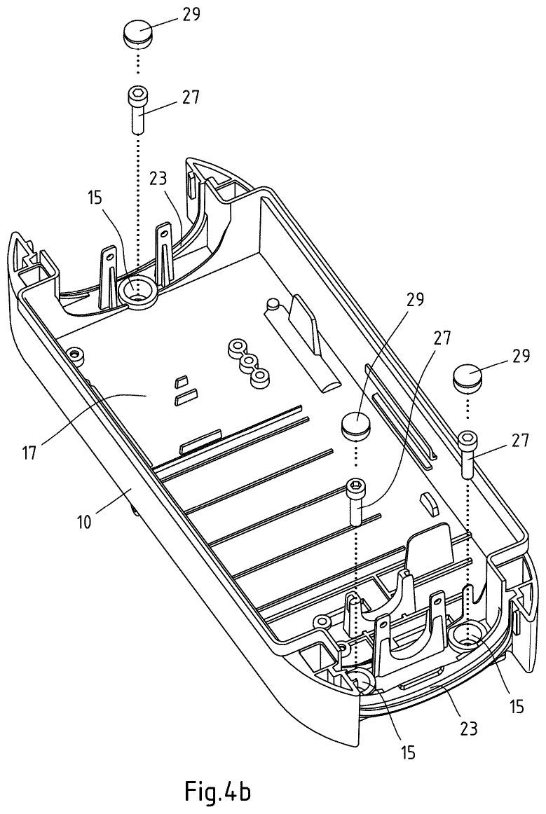

To install the docking station 4, it is first fixed mechanically either in the receptacle 2a or screwed to a wall, for example. For this purpose, as can be seen in FIG. 4a, the docking station 4 has at least one opening 15 in the bottom 17, in this case, in particular, three openings 15.

As can be seen in FIG. 4b, screws 27 can be inserted into the openings 15 to create a mounting connection, in particular, a screw connection, between the charging device 3, in particular, the docking station 4, and the receptacle 2a. Subsequently, a sealing plug 29 is placed on each opening 15 to cover these openings 15 in a sealing manner.

After the docking station 4 has been mounted in the receptacle 2a of the charging station 2, a multi-core power cable is introduced into the interior of the docking station 4, in particular, through the cable entry 8. This cable comprises, in particular, large cable cross-sections and a rigid cable core. Therefore, the cables are difficult to process. In order to ensure that the cables are always cut to the correct length, the fitter can place the cable against the scale 40 and cut it to length immediately. This allows the fitter to assemble the connection cable correctly so that he can place it on the connection strip 38 without any problems in the connection.

Depending on the assembly, a measuring device can be arranged in the receptacle 44. This measuring device is wired via flexible cables starting from the connection strip 38. Starting from the measuring device, wiring is again carried out via flexible cables to a power connection 42. If no measuring device is installed, wiring is carried out directly via a flexible cable between the connection strip 38 and the power connection 42. A connection strip for receiving the respective cables is also provided at the power connection 42.

A network cable and data cable, respectively, can also be inserted into the housing of the docking station 4 via the cable entry 8 and applied to the connections 48.

After the electrical wiring of the docking station 4 has been carried out, the housing of the docking station 4 is closed by a protective housing cover 12, as shown in FIG. 4.

In FIG. 4, it can be seen that the protective housing cover 12 comprises, in addition to the recess 14a for the first power connector 42, at least one further first recess 14b for the communication connectors of the interface board 36, in particular, an RJ45 connector as well as a GPIO connector and a CAN bus connector. Through the RJ45 connector 46, an RJ45 connector can accommodate a connection to two separate LAN networks. A power connection to the charging unit 6 can be established through the first recess 14a, and a data connection to the charging unit can be established through the further first recess 14b.

Openings 16 are provided on the side edges of the protective housing cover 12. The openings 16 are located between the cover 12 and the side wall 10 of the docking station 4. Through the openings 16, the bars 18 of the tub assembly 20 can be inserted into the docking station 4 so that these bars 18 are completely received by the side wall 10 of the docking station 4. Thus, the charging unit 6 can be mechanically anchored within the docking station 4 by the tub assembly 20, as previously described.

After the docking station 4 has been installed in the manner shown, the docking station 4 may remain initially unequipped, protected by the protective housing cover 12, and may be equipped at any later time with a charging unit 6 having a tub assembly 20 and cover assembly 26.

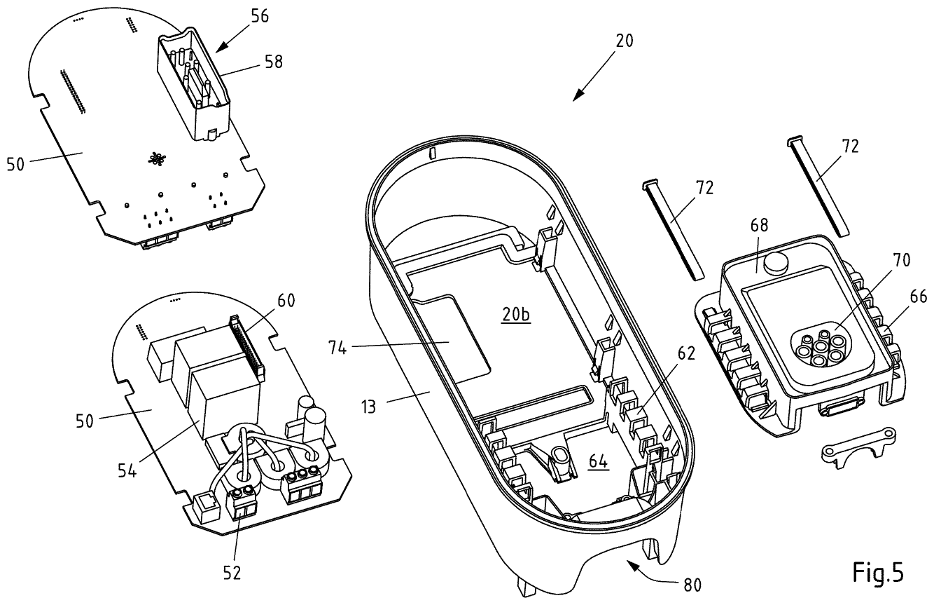

A tub assembly 20 is shown in one equipment variant in FIG. 5 as an example.

The tub assembly 20 comprises a housing with at least a second circumferential side wall 13 and a bottom 20b. In the region of the second side wall 13, respectively of the bottom 20b, a power module 50 can be mechanically anchored on the bottom side in the tub assembly 20 as a charging technology module 50.

In the present embodiment, the power module 50 comprises a charging port 52 and a charging control circuit 54. On the bottom side of the power module 50, as also shown in FIG. 5, a second power connector 56 is arranged in the form of a plug 56 corresponding to the socket of the first power connector 42.

A collar 58 is arranged circumferentially around the plug 56. The collar 58 is facing away from the surface of the circuit board of the power module 50. In particular, the collar 58 comprises an extension in this direction that is greater than the longest extension of any contact of the plug 56.

Further components for power monitoring and/or power control are provided on the power module 50. In addition, a connector 60 for a communication bus is disposed on the power module 50.

The communication bus connector 60 allows the communication bus to be connected to the power module 50. In a plug and play manner, the communication bus can receive and connect both a communication module and a user interface module, which will be described further below, to the power module 50. This makes it possible to add modules to the power module 50 by means of the communication module and/or the user interface module, in order to be able to adapt the charging unit 6 to the respective requirements as needed.

The power module 50 is arranged in a first region of the bottom 20b. A fixing means 62 is provided in a second region of the bottom 20b, which fixing means 62 is formed from flanges arranged in a comb-like manner with openings aligned with one another.

The fixing means 62 is formed of two opposing comb-like structures, which enclose an opening 64 in the bottom 20b. The fixing means 62 correspond to the fixing means 66 of a receptacle body 68 for a charging bushing 70. In the assembled state, the charging bushing 70 is arranged directly above the opening 64. Through the opening 64, it is possible to perform a manual emergency release on the charging bushing 70 from the bottom side of the tub assembly 20, through the bottom 20b.

In order to mount the receptacle body 68 to the tub assembly 20, the mounting body 68 is aligned with its fixing means 66 with respect to the fixing means 62 such that pins 72 can be pushed through the aligned openings. As a result, the pins 72 secure the mounting body 68 to the housing of the tub assembly 20.

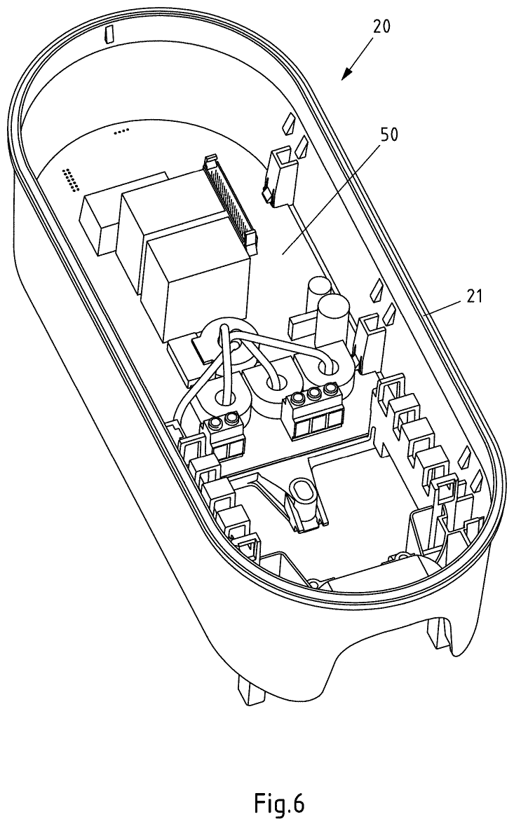

In a partially assembled state, the power module 50 is inserted in the bottom of the tub assembly 20, as exemplified shown by FIG. 6. Here, the connector 56 including the collar 58 is inserted through the second opening 74 on the bottom side (which corresponds to the first opening 14a).

The power module 50 is mechanically snapped with the housing of the tub assembly 20, and may be mounted in a floating manner therein. Alternatively or commutatively, the mains board 34 may be mounted in a floated manner within the housing of the docking station 4. The floating mounting has the advantage that, when the tub assembly 20 is mounted on the docking station 4, the connector 56 and the second power connector 56, respectively, can independently align itself with the socket of the first power connector 42. This increases ease of use, particularly facilitating assembly by a layperson.

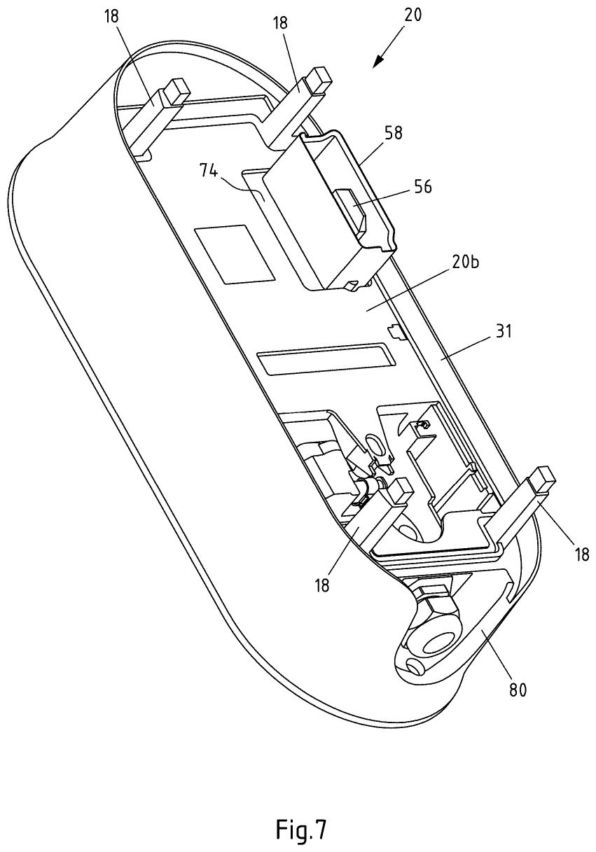

The bottom side of the tub assembly 20 is shown by way of example in FIG. 7. It can be seen that the bars 18 project away from the bottom 20b of the tub assembly 20. Further, the collar 58 with the plug 56 can be seen protruding through the second opening 74. There can be provided further second openings, for example, to provide a data connection between the docking station 4 and the charging unit 6.

The collar 58 comes into engagement with the opening 14a in the assembled state. In the opening 14a, as can be seen in FIG. 4, an annular gap 74 is formed between the socket of the first power connector 42 and a collar 78 projecting into the interior of the housing of the docking station 4. The collar 78 provides contact protection for the docking station 4.

During the assembly, the tub assembly 20 is placed on the docking station 4 and, as can be seen from the combination of FIGS. 4 and 7, the collar 58 slides into the annular gap 76. The collar 58 enters the annular gap 76 before a contact of the connector 56 comes into electrical contact with a contact of the socket of the first power connector 42. This prevents an electric shock from occurring when the tub assembly 20 is mounted to the docking station 4.

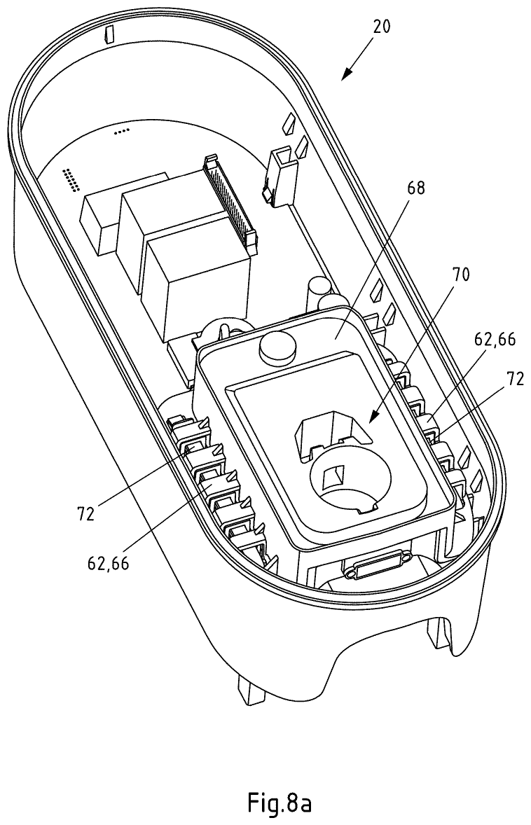

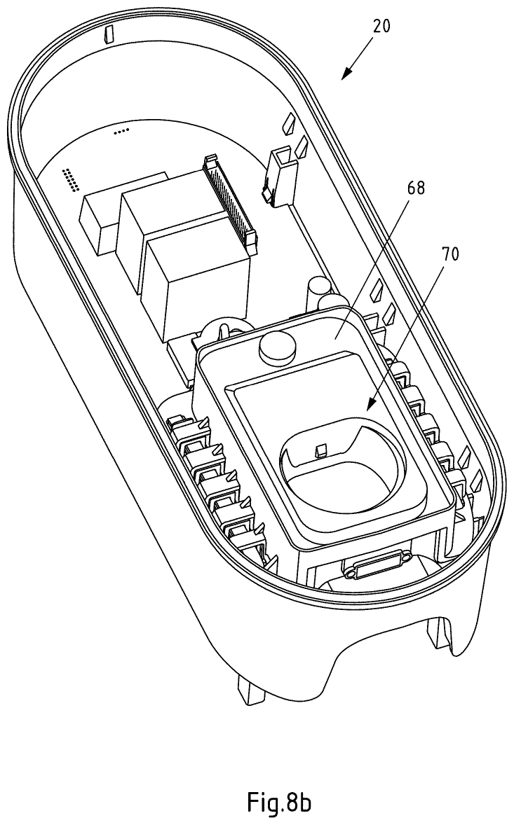

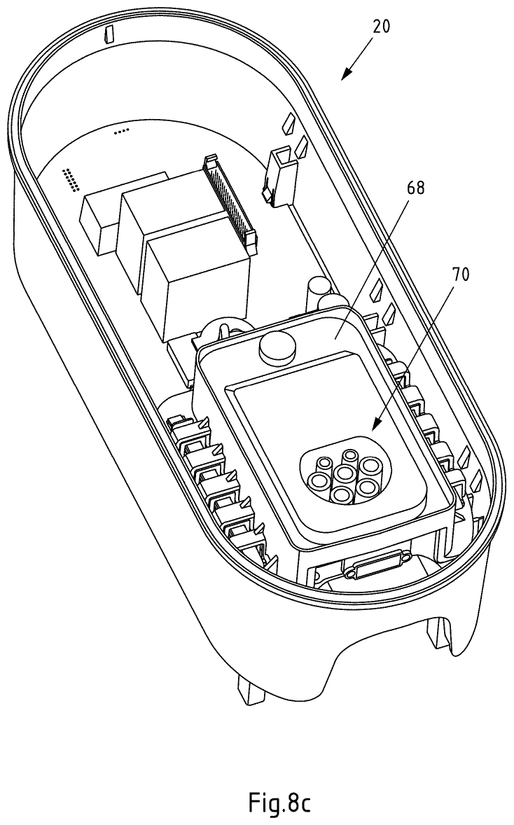

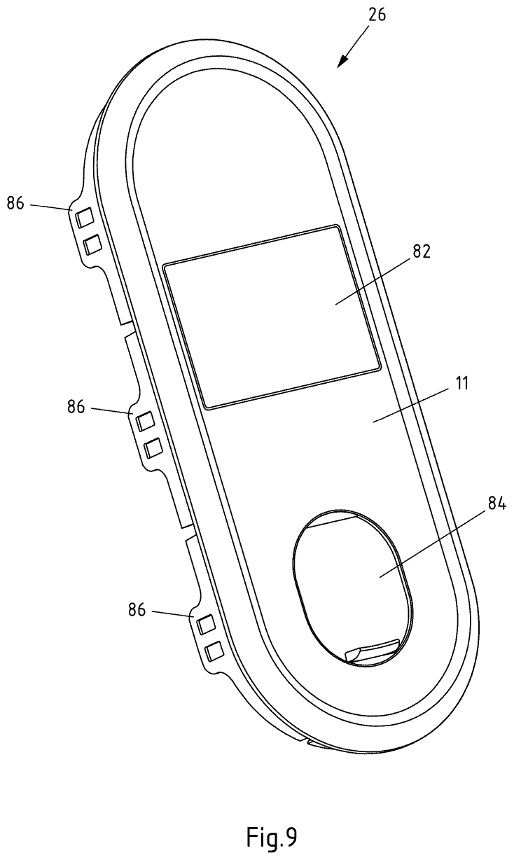

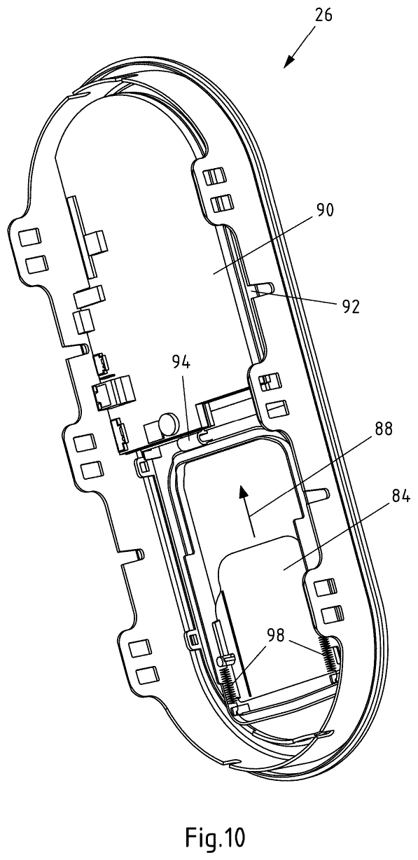

The receptacle body 68 is such that it is configured to receive a wide variety of charging sockets 70, or in other words, a wide variety of charging sockets 70 may be provided with different receptacle bodies 68, wherein in each case the fixing means 66 is at the same distance from one another and thus forming a uniform mechanical interface with the fixing means 62. This results in a wide variety of charging sockets 70 being able to be installed in one and the same tub assembly 20, as can be seen by way of example from FIGS. 8a-c.

There it can be seen that the fixing means 62, 64 engage in one another and are mechanically locked together via the pins 72. FIG. 8a shows a receptacle 68 with a CCS charging socket 70, FIG. 8b shows a receptacle 68 with a Chademo charging socket 70 and FIG. 8c shows a receptacle 68 with a Type2 charging socket 70.

As can be seen in FIGS. 8a-c, the receptacle body 68 makes it possible to accommodate a wide variety of charging sockets 70 without having to make a design change to the housing of the tub assembly 20.

The charging sockets 70 do not necessarily have to be electrically connected to the charging port 52, but may remain potential free. In this case, the charging sockets 70 may serve as a “plug garage”. The charging outlet 52 may be electrically connected to a charging cable fixedly attached to the housing of the tub assembly 20. The charging cable may exit in the region of a recess 80 in the side wall of the tub assembly 20.

If a permanently attached cable is not used, the charging receptacle 70 may be electrically connected to the charging control circuit 54 via the charging port 52. The charging port 52 has three connections for one phase each on one terminal strip, a further terminal strip with two connections for the neutral conductor and the protective conductor and, if necessary, a connection socket for a plug present (PP) contact and a pilot conductor (CP) contact.

In order to install the charging socket 70, the receptacle body 68 is arranged on the tub assembly 20, the charging socket 70 is connected to the respective terminals of the charging outlet 52 via pre-assembled cables, and then the receptacle body 68 is fixed in the tub assembly 20 via the pins 72.

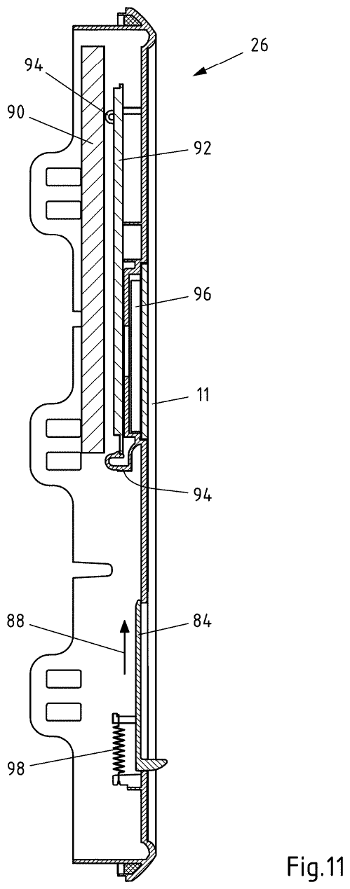

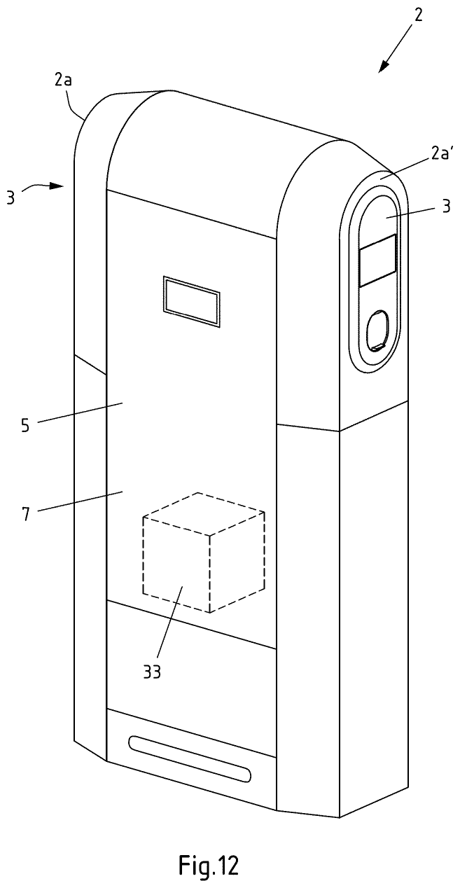

In addition to the tub assembly 20, the charging unit 6 also comprises the cover assembly 26 with the cover 11, as shown in FIG. 9 by way of example.

The top side of the cover assembly 26 may comprise a variety of control elements 82 and/or a shutter 84 on a top surface. At the side of the cover assembly 26, snap elements 86 may preferably be provided on the side edges thereof and may engage the inner second circumferential side wall of the tub assembly 20. This allows the cover assembly 26 to be mounted on the tub assembly 20, as described above.

The snap elements 86 may be configured such that they snap to the second sidewall of the tub assembly 20 and, in particular, can be non-destructively disengaged only when disengaged from the bottom side, starting from the bottom 20b of the tub assembly 20. This prevents the cover assembly 26 from being disengaged from the tub assembly 20 while the tub assembly 20 is still electrically connected to the mains board 34 of the docking station 4.

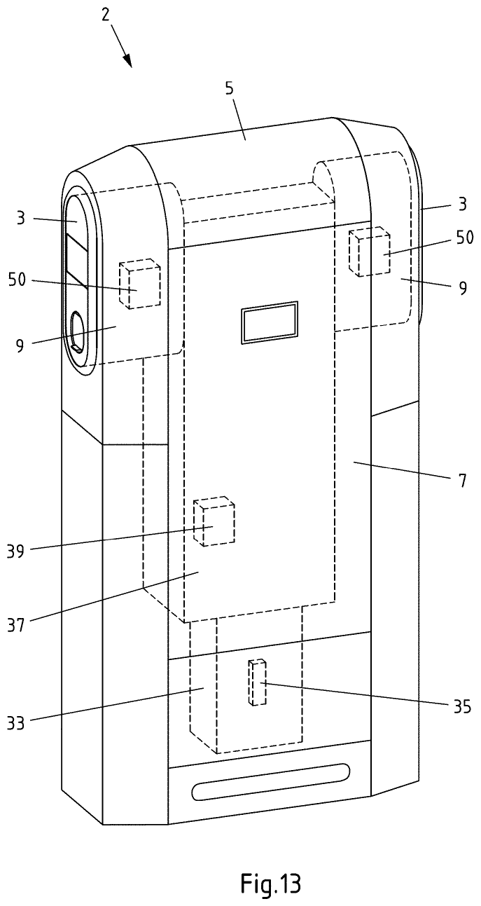

At the rear side of the cover assembly 26, as shown in FIG. 10, the shutter 84 is supported so that it can be moved in a direction of movement 88 to release the charging port 70. As shown by way of example in FIG. 11, the shutter 84 is spring-loaded by a spring 98 so that it automatically moves to the closed position shown.

A communication module 90 and a user interface module 92 may be disposed in a further portion of the cover assembly 26. The communication module 90 as well as the user interface module 92 may be mechanically fixed to the cover assembly 26 and its housing, respectively.

The communication module 90 is connected to the power module 50 and the user interface module 92 via the communication bus.

The communication module 90 comprises a charging control circuit, not shown in detail here, that has electrical access to the charging port 52. The charge control circuit may override, or at least be coupled to, the charge control circuit 54 so that the two charge control circuits may coordinate a control of a charging process.

FIG. 11 shows the arrangement of the communication module 90 as well as the user interface module 92 in the cover assembly 26. The user interface module 92 faces the inner side of the cover wall and is mechanically connected to the housing of the cover assembly 26 via click connections 94. The communication module 90, in turn, is also connected to the housing of the cover assembly 26 via connections not shown in detail.

The user interface module 92 is stationary with respect to the inner side of the cover assembly 26, such that precise positioning of sensors and signaling devices on the user interface module 92 with respect to the top side of the cover assembly 26 is assured. In particular, a display % may be optionally disposed within the cover assembly 26 and controlled by the user interface module 92 and/or the communication module 90.

FIG. 12 shows a schematic view of a charging station 2 according to the present application. The charging station comprises a charging column 5 with a charging column housing 7 which is not completely sealed. In the present case, the charging column housing 7 of the charging column 5 has a respective receptacle 2a for a respective charging device 3 on two opposing front surfaces.

Each charging device 3 again has a fully sealed, in particular, to IP55, charging device housing. In order to arrange further electrical components in the charging column, if required, a sealed distribution box 33 can preferably be arranged in the charging column housing 7.

FIG. 13 shows a schematic view of a further embodiment of a charging station 2. The charging station 2 comprises a charging column housing 7 which is not completely sealed. Furthermore, charging devices 3 are mounted in receptacles 2a.

Each charging device 3 comprises a fully sealed charging device housing 9. Further, additional sealed distribution boxes 33, 37 may be provided to protect additional electrical components 35, 39 from water, dirt particles, etc.

### REFERENCE LIST

2 charging station
2a receptacle
3 charging device
4 docking station
5 charging column
6 charging unit
7 charging column housing
8 cable entry
9 charging unit housing
10 first circumferential side wall
11 cover
12 protective housing cover
13 second circumferential side wall
14 recess
15 opening in the bottom of the docking station
16 opening
17 bottom of the docking station
18 bar
19 sealing element
20 tub assembly
21 sealing element
22 power module
23 plate receptacle
24 charging socket
25 cable feed-through plate
26 cover assembly
27 screws
28 snap elements
29 sealing plugs
30 snap elements
31 collar
33 distribution box
34 mains board
35 electrical component
36 interface board
37 distribution box
38 connection strip
39 electrical component
40 scale
41 locking module
42 power connection
44 receptacle
46 connecting socket
48 connectors
50 power module
52 charging connection
54 charge control circuit
56 plug
58 collar
60 connector
62 fixing means
64 opening
66 fixing means
68 receptacle body
70 charging socket
72 pin
74 opening
76 annular gap
78 collar
80 recess
82 operating element
84 shutter
86 snap element
88 direction of movement
90 communication module
92 user interface module
94 click connection
96 display

What is claimed is:

1) A charging station for electric vehicles, comprising:
at least one charging column with a charging column housing,
wherein at least one receptacle is arranged in the charging column housing, configured to receive a charging device with a charging device housing, wherein the charging device corresponds to the receptacle,
wherein at least one charging technology module is integrated in the charging device housing, and
wherein only the charging device housing is completely sealed from the charging device housing and the charging column housing.

2. The charging station according to claim 1, characterized in that
the charging device housing is at least completely sealed with a tightness of IP55 according to the standard DIN EN 60529.

3. The charging station according to claim 1, characterized in that
the charging column housing is not completely sealed, in particular, not with a tightness of IP55 according to the standard DIN EN 60529.

4. The charging station according to claim 1, characterized in that
the charging device comprises a charging unit that is connectable to a docking station,
wherein the docking station comprises at least a bottom and a first circumferential side wall,
wherein the charging unit comprises at least a cover and a second circumferential side wall, and
wherein, in the assembled state of the charging device, the base, the first side wall, the second side wall and the cover form the charging device housing of the charging device.

5. The charging station according to claim 4, characterized in that
the charging unit comprises a tub assembly and a cover assembly,
wherein the tub assembly comprises a tub bottom and at least partially the second side wall,
wherein the cover assembly comprises the cover, and
wherein the cover assembly corresponds over its entire surface to the tub assembly and is connectable to the tub assembly in a sealing manner by means of snap elements which, in particular, snap on the inner side of the second side wall of the tub assembly.

6. The charging station according to claim 5, characterized in that
the tub assembly accommodates the charging technology module, in particular, in the form of a printed circuit board, and
in particular, the cover assembly accommodates a communication module and/or a user interface module.

7. The charging station according to claim 4, characterized in that
bottom side arranged bars extend away from the interior of the tub assembly,
wherein the bars are configured to engage in recesses on the docking station such that the bars are positively fixable to the docking station to sealingly couple the docking station to the charging unit.

8. The charging station according to claim 4, characterized in that
the docking station comprises a protective housing cover,
wherein the first side wall projects in a collar-like manner beyond the protective housing cover in the assembled state of the protective housing cover.

9. The charging station according to claim 8, characterized in that
the second side wall corresponds to the first side wall in such a way that, in the assembled state of the charging device, the second side wall circumferentially encloses the first side wall,
wherein at least one circumferential sealing element is provided, which is held in a clamped manner between the first side wall and the second side wall in the assembled state of the charging device.

10. The charging station according to claim 8, characterized in that
in the assembled state of the charging device, at least one first opening in the protective housing cover corresponds to at least one second opening in the tub bottom in such a way that a power connection and/or a communication connection is establishable between the charging unit and the docking station through the first opening and the second opening.

11. The charging station according to claim 1, characterized in that
a distribution box is integrated in the charging column housing,
wherein the distribution box is configured to accommodate at least one further electrical component.

12. The charging station according to claim 1, characterized in that
the docking station can be mounted in the receptacle of the charging station by establishing at least one mounting connection, in particular, a screw connection, through at least one opening arranged in the bottom of the docking station,
wherein, in the mounted state of the docking station, the at least one opening in the base of the docking station is sealed by a sealing plug.

13. The charging station according to claim 1, characterized in that
an annular gap is between the docking station and the circumferential side wall forming the receptacle in the mounted state of the docking station, and
the second side wall of the charging unit, which is electrically and mechanically connected to the docking station in the mounted state of the charging device, engages in the annular gap.

14. The charging station according to claim 1, characterized in that
the charging column housing of the charging station comprises on two opposing front surfaces a receptacle for one charging device in each case.
